(19) United States
(12) Patent Application Publication
(10) Pub. No.: US 2013/0064513 A1
(43) Pub. Date: Mar. 14, 2013

(54) OPTICAL FIBER

(71) Applicants: Takuji NAGASHIMA, Yokohama-shi (JP); Toshiki Taru, Yokohama-shi (JP); Kazuya Kuwahara, Yokohama-shi (JP)

(72) Inventors: Takuji NAGASHIMA, Yokohama-shi (JP); Toshiki Taru, Yokohama-shi (JP); Kazuya Kuwahara, Yokohama-shi (JP)

(73) Assignee: SUMITOMO ELECTRIC INDUSTRIES, LTD., Osaka-shi (JP)

(21) Appl. No.: 13/593,743

(22) Filed: Aug. 24, 2012

(30) Foreign Application Priority Data
Sep. 14, 2011 (JP) 2011-201039

(51) Int. Cl. G02B 6/02

(52) U.S. Cl. 385/123

(57) ABSTRACT

An optical fiber has a plurality of holes in a cladding around a core, and has a high failure strength and small transmission loss. The core is made of glass. The cladding surrounds the core, and the holes are formed in the cladding so as to extend along a central axis of the fiber. The holes are formed with constant intervals therebetween along a circle centered on the core, and each hole has a substantially circular cross section. The cladding is sectioned into two claddings. A residual stress in an inner region that is inside a circumcircle of the holes is a compressive stress.

### BACKGROUND OF THE INVENTION

1. Field of the Invention

The present invention relates to an optical fiber having a plurality of holes in a cladding around a core.

2. Description of the Related Art

Optical fibers having a plurality of holes that extend along the central axes of the fibers are known. Optical fibers having such holes are capable of having more properties compared to those of solid optical fibers that do not have the holes.

Japanese Unexamined Patent Application Publication (Translation of PCT Application) No. 2005-538029 describes an optical fiber including an inner region having holes formed therein and an outer region around the inner region. The inner region is formed of a material having a higher softening point than that of the material of the outer region. With this structure, the holes are inhibited from distorting during drawing, and an optical fiber having desired properties can be manufactured. In this optical fiber, the material of the outer region solidifies while a tensile stress remains in the material of the inner region in the drawing process. As a result, a tensile stress remains in the inner region including wall surfaces of the holes. Therefore, this optical fiber easily causes breakages starting from the wall surfaces of the holes, and transmission loss increases owing to Rayleigh scattering.

### SUMMARY OF THE INVENTION

An object of the present invention is to provide an optical fiber that has a plurality of holes in a cladding around a core and that has a high failure strength and small transmission loss.

An optical fiber according to an aspect of the present invention includes a core and a cladding that surrounds the core, the cladding having a plurality of holes that extend along a central axis of the fiber. A residual stress in an inner region that is inside a circumcircle of the holes is a compressive stress.

In the optical fiber according to the aspect of the present invention, the compressive stress is preferably 15 MPa or more. In addition, in the optical fiber according to the aspect of the present invention, a molar concentration of a halogen in the inner region is preferably higher than that in a region of the cladding around the inner region. Preferably, chlorine and fluorine are codoped in the inner region.

The optical fiber according to the aspect of the present invention has the holes in the cladding around the core, and has a high failure strength and small transmission loss.

### BRIEF DESCRIPTION OF THE DRAWINGS

FIG. 1 is a conceptual diagram illustrating the cross sectional structure and refractive index profile of an optical fiber according to an embodiment of the present invention.

FIG. 2 is a conceptual diagram illustrating the cross sectional structure and refractive index profile of an optical fiber according to an embodiment of the present invention.

FIG. 3 is a conceptual diagram illustrating the cross sectional structure and refractive index profile of an optical fiber according to an embodiment of the present invention.

FIG. 4 is a conceptual diagram illustrating the refractive index profile and stress distribution of an optical fiber according to a comparative example.

FIG. 5 is a conceptual diagram illustrating the refractive index profile and stress distribution of an optical fiber according to an example of the present invention.

### DESCRIPTION OF THE PREFERRED EMBODIMENTS

Embodiments of the present invention will now be described with reference to the drawings. The drawings are for illustrative purposes, and are not intended to limit the scope of the present invention. To avoid redundancy of explanation, similar components are denoted by the identical reference numerals in the drawings. The dimensional ratios in the drawings are not necessarily correct.

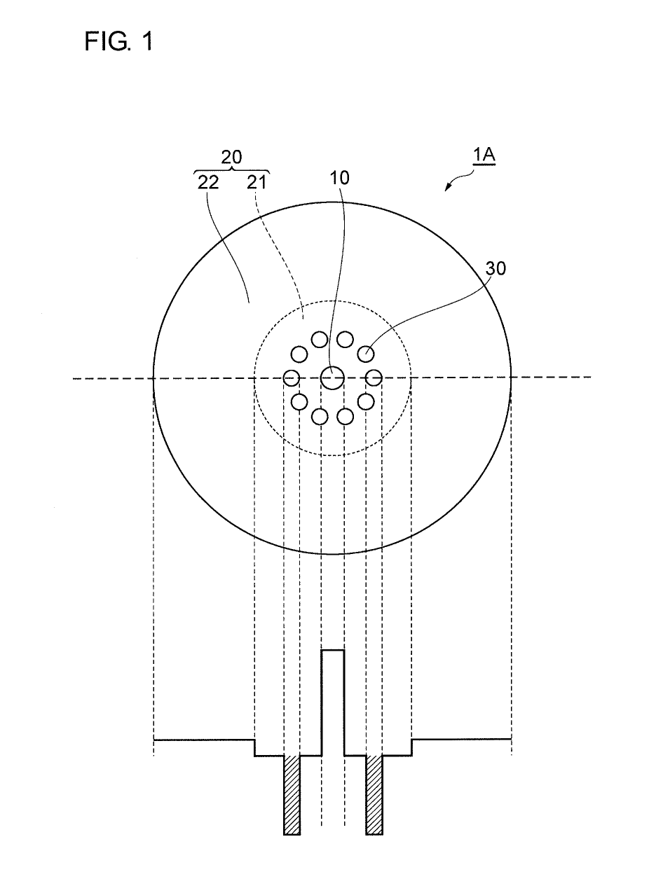

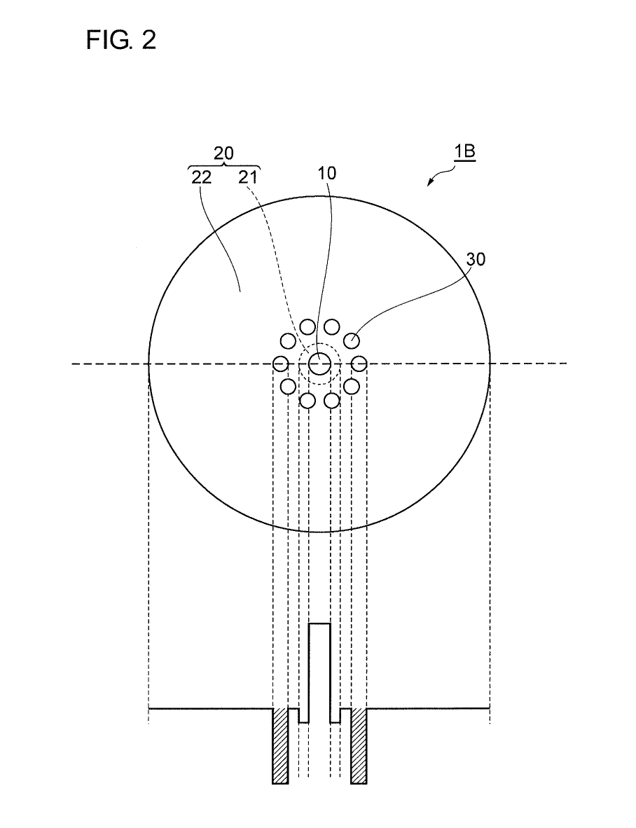

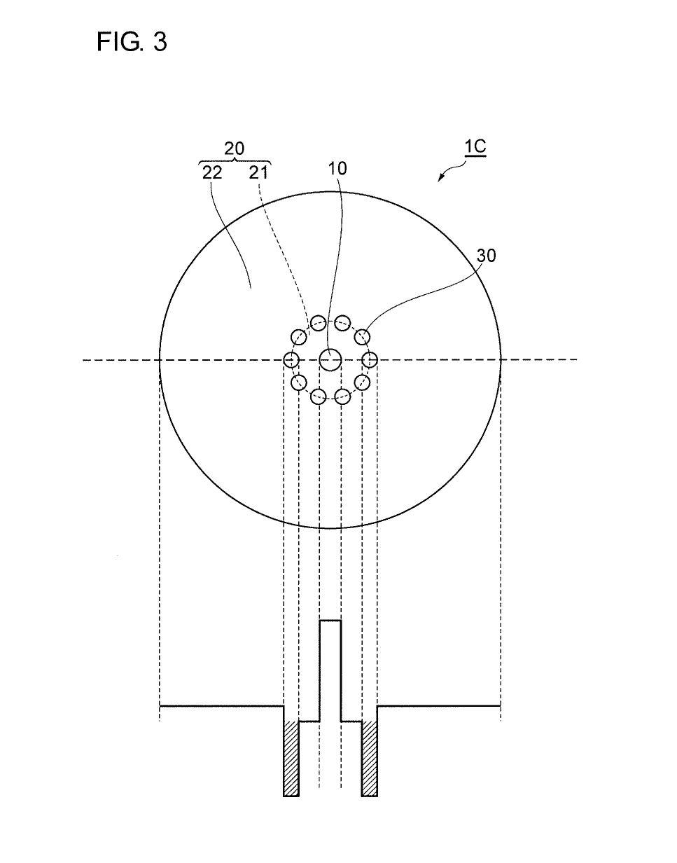

FIGS. 1 to 3 are conceptual diagrams illustrating the cross sectional structures and refractive index profiles of optical fibers 1A to 1C according to embodiments of the present invention. In each figure, the upper half shows the cross sectional structure and the lower half shows the refractive index profile along the broken line in the sectional view. The optical fibers 1A to 1C are called hole-assisted fibers (HAF). Each of the optical fibers 1A to 1C includes a core 10 made of glass, a cladding 20 made of glass that surrounds the core 10, and a plurality of holes 30 formed in the cladding 20 so as to extend in an axial direction of the fiber. The holes 30 are formed with constant intervals therebetween along a circle centered on the core 10, and each hole 30 has a substantially circular cross section. Although the number of holes 30 is ten in the drawings, the number of holes 30 is not limited to this.

The cladding 20 is sectioned into a cladding 21 and a cladding 22. In the optical fiber 1A, the boundary between the claddings 21 and 22 is outside the circumcircle of the holes 30. In the optical fiber 1B, the boundary between the claddings 21 and 22 is inside the incircle of the holes 30. In the optical fiber 1C, the boundary between the claddings 21 and 22 is between the circumcircle and the incircle of the holes 30. The claddings 21 and 22 are made of glasses of different origins when an optical fiber preform is produced.

The core 10 has a higher refractive index than that of the cladding 20. The core 10 may be made of quarts glass doped with GeO₂. The cladding 20 may be made of quarts glass doped with a halogen. The claddings 21 and 22 may have either the same refractive index or different refractive indices.

The optical fibers 1A to 1C are capable of suppressing bleeding of light toward the outside beyond the holes 30 and confining most part of the light that is guided through the core 10 within the region inside from the holes 30. The bend loss of the optical fibers 1A to 1C is reduced owing to the holes 30 formed around the core 10.

Therefore, when a hole-assisted fiber (HAF) is manufactured by drawing an optical fiber preform, it is important to precisely control the hole diameter in the drawing process. To control the hole diameter in the drawing process, it is necessary to stabilize the internal pressure of the holes. It is also necessary to perform high-tensile drawing so that drawing is carried out while the viscosity of the glass is relatively high. However, tensile stress easily remains around the core when high-tensile drawing is performed, and the residual tensile stress may cause a reduction in the strength of the glass and an increase in transmission loss.

In the optical fibers according to the embodiments of the present invention, a residual stress in an inner region that is inside the circumcircle of the holes is a compressive stress. Therefore, the optical fibers according to the embodiments of the present invention have a high failure strength and a low transmission loss. The compressive stress is preferably 15 MPa or more. In such a case, the failure strength can be reliably increased and the transmission loss can be reliably reduced.

In the optical fibers according to the embodiments of the present invention, a molar concentration of a halogen in the inner region is preferably higher than that in a region of the cladding around the inner region. In this case, the viscosity in the inner region can be reduced and the stress in the inner region can be set to a compressive stress. Preferably, chlorine and fluorine are codoped in the inner region. Here, chlorine is a dopant that increases the refractive index, and fluorine is a dopant that decreases the refractive index. When chlorine and fluorine are codoped in the inner region, the viscosity in the inner region can be reduced while the refractive index of the inner region is set to a desired value.

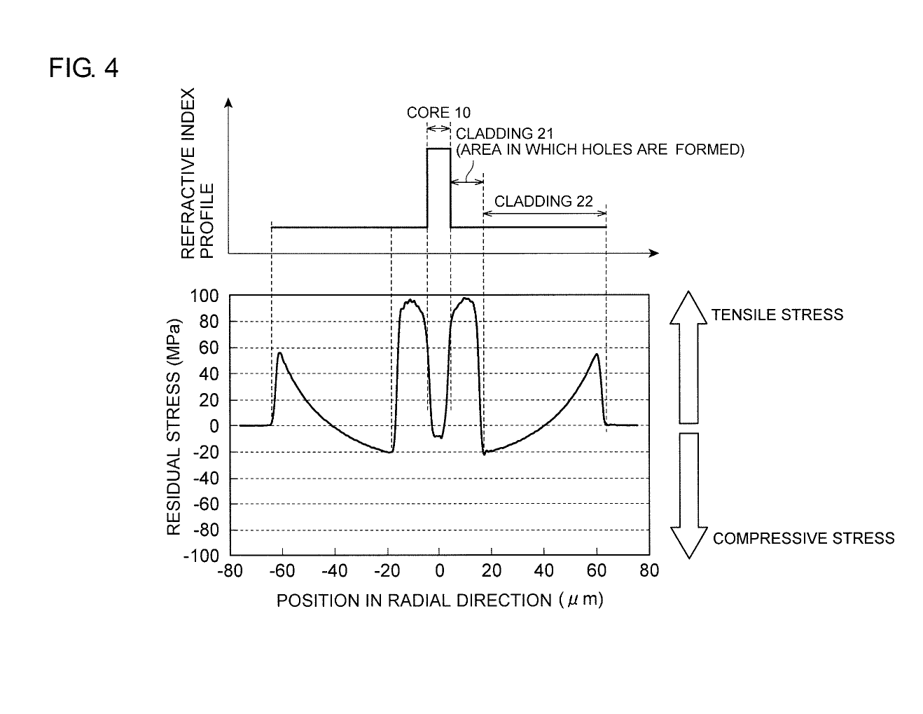

FIG. 4 is a conceptual diagram illustrating the refractive index profile and stress distribution of an optical fiber according to a comparative example. The upper half shows the refractive index profile, and the lower half shows the stress distribution. In the optical fiber according to the comparative example, the residual stress in an inner region that is inside the circumcircle of the holes is a tensile stress. The core 10 is doped with 7.24 wt % of GeO₂. The cladding 21 is doped with 0.12 wt % of chlorine. The cladding 22 is doped with 0.39 wt % of chlorine. The concentration of chlorine in the cladding 21 is smaller than that in the cladding 22. Therefore, the viscosity of the cladding 21 is higher than that of the cladding 22, and the residual stress in the cladding 21 in which the holes are formed is a tensile stress. The transmission loss of the optical fiber of the comparative example at a wavelength of 1.55 μm is 0.22 dB/km.

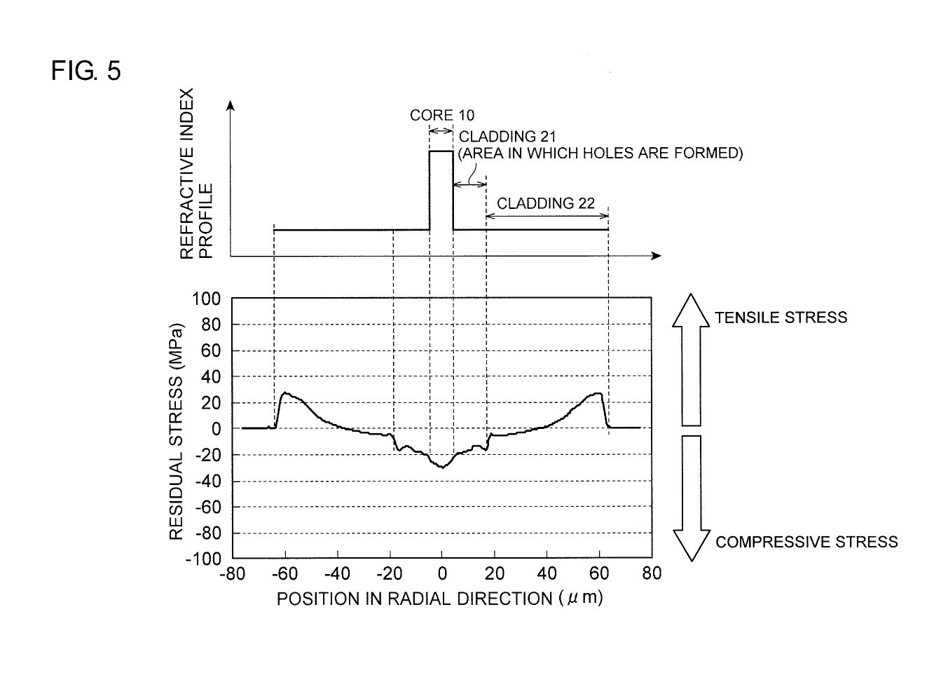

FIG. 5 is a conceptual diagram illustrating the refractive index profile and stress distribution of an optical fiber according to an example of the present invention. The upper half shows the refractive index profile, and the lower half shows the stress distribution. In the optical fiber according to the example, the residual stress in an inner region that is inside the circumcircle of the holes is a compressive stress. The core 10 is doped with 7.24 wt % of GeO₂. The cladding 21 is doped with 0.12 wt % of chlorine and 0.05 wt % of fluorine. The cladding 22 is doped with 0.12 wt % of chlorine. The halogen concentration in the cladding 21 is larger than that in the cladding 22. Therefore, the viscosity of the cladding 21 is lower than that of the cladding 22, and the residual stress in the cladding 21 in which the holes are formed is a compressive stress of 15 MPa or more. The transmission loss of the optical fiber of this example at a wavelength of 1.55 μm is 0.20 dB/km. Since the residual stress is the compressive stress, the transmission loss is reduced. In addition, since the pressure applied to the wall surfaces of the holes is the compressive stress in the optical fiber of the example, failure strength against breakages starting from the wall surfaces of the holes can be increased. Thus, the failure strength is increased.

When the pressure applied to the wall surfaces of the holes is set to the compressive stress, there is a risk that the holes will be distorted since the viscosity of the wall surfaces of the holes is small in the drawing process. In the case of a photonic crystal fiber in which light is confined by a plurality of holes that are two-dimensionally and periodically arranged, there is a risk that the transmission loss will be increased by the distortion of the holes. However, in the case of an HAF, the number of holes is small, such as ten, and light is confined by using the difference in the refractive index between the core and the optical claddings. Therefore, the influence of distortion of the holes on the transmission loss is small and does not cause any problem.

What is claimed is:

1. An optical fiber comprising:
a core; and
a cladding that surrounds the core, the cladding having a plurality of holes that extend along a central axis of the fiber,
wherein a residual stress in an inner region that is inside a circumcircle of the holes is a compressive stress.

2. The optical fiber according to claim 1,
wherein the compressive stress is 15 MPa or more.

3. The optical fiber according to claim 1,
wherein a molar concentration of a halogen in the inner region is higher than that in a region of the cladding around the inner region.

4. The optical fiber according to claim 3,
wherein chlorine and fluorine are codoped in the inner region.
